(19) United States
(12) Patent Application Publication
(10) Pub. No.: US 2016/0327491 A1
(43) Pub. Date: Nov. 10, 2016

(54) COLORIMETRIC INDICATOR RESPONSIVE TO AIR FLOW

(71) Applicant: 3M Innovative Properties Company, Saint Paul, MN (US)

(72) Inventor: Robert L. WOOD, Cary, NC (US)

(21) Appl. No.: 15/108,787

(22) PCT Filed: Jan. 6, 2015
(86) PCT No.: PCT/US2015/010286

§ 371 Date: Jun. 29, 2016

Related U.S. Application Data
(60) Provisional application No. 61/924,002, filed on Jan. 6, 2014.

(51) Int. Cl. G01N 21/80; G01N 15/08; B01D 46/00

(52) U.S. Cl. CPC G01N 21/80; B01D 46/0086; G01N 15/082; G01N 2015/084

(57) ABSTRACT

Provided is an indicator device responsive to air flow that may signal the need to change an air filter after a prescribed amount of airflow has passed the air filter or clogging of the air filter has occurred. The indicator device may be mounted on the outer surface of the filter where visible for inspection. After a prescribed amount of airflow has passed the air filter or clogging of the air filter has occurred, the indicator device may change color, thereby alerting the user of the need to replace the air filter.

### FIELD

The present disclosure relates to monitoring airflow within an HVAC air passage for the purpose of alerting occupants of the need to replace or clean an air filter. The present disclosure also relates to assessing the degree of flow deterioration, or “clogging” within an air filter.

### BACKGROUND

Most modern heating, ventilating, and air conditioning (HVAC) systems employ user-accessible panel filters for removal of particulate matter present in the airstream. Various types of disposable and non-disposable panel filters are used within receptacles interfaced with the HVAC's air delivery ducts, typically on the air return side of an HVAC circuit. Such filter receptacles are conventionally located in user-accessible locations to facilitate easy change-out or maintenance of the filters. Some filters used in HVAC return air receptacles are designed with a large porosity to maximize air flow and minimize pressure drop. Such filters may only remove relatively large (greater than about 10 μm) particles and primarily guard against buildup of lint and other debris inside the system's air handling components. Buildup could otherwise impair system performance over time and could eventually lead to loss of efficiency and/or premature system failure.

Other filter types are designed to improve indoor air quality (IAQ) for occupants by removing a substantial portion of small particles such as pollen, pet dander, dust, and other fine particulate matter. Such IAQ filters not only protect the HVAC system, but help protect occupants from potentially harmful air. These filters generally have a finer porosity and provide greater resistance to airflow than system-protective filter types. IAQ filters are generally much more expensive and require more frequent changing than the former type. Due to trends in home construction and consumer preference, the market has shifted toward greater use of IAQ filters in residential HVAC installations. Well-insulated and tightly constructed homes can tend to have poor air quality and therefore may benefit from fine filtration of air handled by the HVAC system. Consumers now have a wide variety of IAQ filters to select from in retail or online sources.

Applicant has identified deficiencies and problems associated with conventional processes for indicating the need for a filter replacement. Through applied effort, ingenuity, and innovation, certain of these identified problems have been solved by developing solutions that are included in various embodiments of the present invention, which are described in detail below.

### SUMMARY

Embodiments of the present invention provide an indicator device that is responsive to air flow and that indicates the need to replace an air filter and a method of manufacturing an indicator device.

A simple, effective means for signaling the user and/or occupant that an air filter is near its end-of-life and requires replacement or cleaning is provided. Various embodiments according to the present disclosure provide a color-change material configured to visually change color in response to a predetermined amount of air flow. The color-change material may interact with the air flow in a manner that causes a visual change in color after a specific amount of air flow has passed across, through, or near the indicator device and air filter.

In some embodiments of the present invention, an indicator device responsive to gas flow is provided that comprises indicator support media and a first color-change material, wherein the first color-change material is deposited on the indicator support media and comprises a reactive component and an indicator dye, wherein the first color-change material changes color when activated by a gaseous stream passing across, through, or near the indicator device. In some embodiments, the indicator support media comprises paper, cloth, foam, synthetic fibrous material, or combinations thereof. In one embodiment of the present invention, the indicator support media comprises filter paper.

In certain embodiments of the present invention, the reactive component comprises a solid material that becomes impregnated in the indicator support media. In some embodiments, the reactive component comprises one or more alkaline materials. In one embodiment, the reactive component reacts with one or more indicator gases of the gaseous stream. In one embodiment, the reactive component is selected from one or more quaternary ammonium hydroxides, alkali hydroxides, and alkaline earth hydroxides. In some embodiments, the reactive component comprises tetramethylammonium hydroxide, potassium hydroxide, sodium hydroxide, calcium hydroxide, or combinations thereof. In other embodiments, the reactive component is selected from one or more quaternary ammonium carbonates, alkali carbonates, and alkaline carbonates. In some embodiments, the reactive component comprises one or more alkaline salts including tetramethylammonium carbonate, sodium carbonate, or potassium carbonate.

In some embodiments of the present invention, the gaseous stream comprises an air stream entering an air filter or an air stream exiting an air filter. In one embodiment, the one or more indicator gases comprises nitrogen, oxygen, carbon dioxide, or combinations thereof. In some embodiments, the first color-change material is activated by the reaction between the reactive component and one or more indicator gases of the gaseous stream.

In some embodiments of the present invention, the indicator dye comprises a compound that changes from a first color to a second color with a change in pH. In certain embodiments, the indicator dye comprises one or more pH indicators selected from the group consisting of phenol red, thymol blue, metacresol purple, bromthymol blue, bromcresol green, methyl red, phenolphthalein, thymophthalein, cresol red, and alizarin yellow R.

In one embodiment of the present invention, the indicator device further comprises one or more integral color references within or adjacent to the color-change material. In another embodiment, the indicator device further comprises one or more attachment elements. The attachment elements in certain embodiments comprise magnets, tape, adhesives, brackets, hooks, hook and loop patches, or combinations thereof.

In still further embodiments, the first color-change material is divided into one or more segments wherein each segment responds individually to gas flow. In some embodiments, the indicator device comprises a second color-change material comprising a reactive component and an indicator dye wherein the second color-change material changes color when activated by a gaseous stream passing across, through, or near the indicator device. In some embodiments, the second-color change material is deposited on the indicator support media adjacent to or near the first color-change material. In yet other embodiments, the color-change material forms a word, symbol, image, or combinations thereof on the indicator support media.

Embodiments of the present invention provide a method of preparing an indicator device comprising preparing a first color-change material comprising a reactive component and an indicator dye; applying the first color-change material to at least a portion of indicator support media; and drying the indicator support media to obtain the indicator device, wherein the first color-change material changes color when activated by a gaseous stream passing across, through, or near the indicator device. In some embodiments of the present invention, the method of preparing an indicator device further comprises adding one or more acids, surfactants, humectants, or combinations thereof to the solution of the first color-change material. In one embodiment of the present invention, the method of preparing an indicator device further comprises preparing a second color-change material comprising a reactive component and an indicator dye, applying the second color-change material to the indicator support media, and drying the second color-change material, wherein the second color-change material changes color when activated by a gaseous stream passing across, through, or near the indicator device.

Embodiments of the present invention provide an air filtration system comprising an air filter and the indicator device. In some embodiments of the present invention, the air filtration system comprises an indicator device responsive to gas flow comprising indicator support media and a first color-change material, wherein the first color-change material is deposited on the indicator support media and comprises a reactive component and an indicator dye, wherein the first color-change material changes color when activated by a gaseous stream passing across, through, or near the indicator device. In one embodiment of the present invention, the air filtration system is connected to a heating system, ventilating system, air conditioning system, air filtration system, or combinations thereof.

Embodiments of the present invention provide a method of assembling an air filtration system including the steps of attaching the indicator device to an air filter; and covering at least a portion of the indicator device with a removable covering, wherein the removable covering substantially prevents air from contacting the color-change material of the indicator device during storage. In some embodiments of the present invention, the method of assembling an air filtration system comprises an indicator device responsive to gas flow comprises indicator support media and a first color-change material deposited on the indicator support media, wherein the first color-change material comprises a reactive component and an indicator dye, wherein the first color-change material changes color when activated by a gaseous stream passing across, through, or near the indicator device.

In some embodiments, the indicator device provides a color-change indicating the degree of clogging of an air filter. In one embodiment, the present invention provides a means for detecting, via a visual color change of a color-change material, the need to change an air filter. In certain embodiments where the indicator device provides a color-change indicating the degree of clogging of an air filter, the filter is equipped with a bypass mode to channel air from the filter to the indicator device once the filter becomes clogged. In some embodiments, a pressure differential across the filter channels air or a gaseous stream from the filter to the indicator device.

In some embodiments of the present invention, color-change material is provided that interacts with one or more components present in air in order to effect a visual color change. The color-change material may be visible to a user. In some embodiments, a panel type filter is provided that is suitable for HVAC application wherein the filter panel is integrated with a color-change material. Some embodiments of the present invention provide a device configured to channel airflow to the indicator device and the color-change material in order to optimize the accuracy and response of the indicator device. Further embodiments of the present invention provide a method of packaging new filters in a manner that may protect the color-change material from exposure to air prior to installation in a filtration system.

These embodiments of the present invention and other aspects and embodiments of the present invention are described further herein and will become apparent upon review of the following description taken in conjunction with the accompanying drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic representation of an indicator device in accordance with some embodiments of the present invention;

FIG. 2 is a schematic representation of a front (dwelling side) view of a filter with an indicator device mounted near the perimeter of the filter in accordance with some embodiments of the present invention;

FIG. 3 is a schematic representation of a front (dwelling side) view of a filter with a centrally mounted indicator device in accordance with some embodiments of the present invention;

FIG. 4 is a schematic representation of a multi-segment indicator device at three stages of filter life in accordance with some embodiments of the present invention;

FIG. 5 is a schematic representation of an indicator device at three stages of filter life in accordance with some embodiments of the present invention;

FIG. 6 is a schematic representation of an air filter with a bypass mode and an indicator device in accordance with some embodiments of the present invention;

FIG. 7 is a schematic representation of an air filter with a bypass mode and an indicator device with a protective transparent cover in accordance with some embodiments of the present invention;

FIG. 8 is a schematic representation of an indicator device in a linear split configuration at three stages of filter life in accordance with some embodiments of the present invention;

FIG. 9 is a schematic representation of an indicator device in a radial split configuration at three stages of filter life in accordance with some embodiments of the present invention; and

FIG. 10 is a schematic representation of an indicator device in a radial split configuration with exposed edges at three stages of filter life in accordance with some embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As filters clog with particles, the flow of air through them is impeded and eventually declines to a point where flow through the HVAC system is restricted. This “clogging” can reduce efficiency of the system and put excess strain on the air handler. It is generally recommended that fine-particle IAQ filters sold for use in residential HVAC applications are changed at a specific time interval, for example, every three months. However, the rate of particle loading of a particular filter varies greatly from home-to-home and user-to-user. For example, filters used in a home with many occupants and pets may clog at a faster rate than a home with only one or two occupants and no pets. Similarly, filters may clog faster in climates requiring a large HVAC run time compared to more temperate climates. Fine particles are more abundant than large particles in most air samples, so filters designed for removing fine particles will tend to clog faster than more coarse filters.

Newer types of HVAC filters employ so-called “electret” filter material which carries a static electrical charge to help trap particles within the material. Such filters take advantage of the property of some fine particles to carry electrical charge. Electret filters capture particles by electrostatic attraction rather than mechanical immobilization. Such filters thus do not “clog” in the conventional sense, but still lose efficiency as more and more particles are trapped by neutralization of the electret charge. Consequently, it is difficult to assess the state of such a filter over time since its flow resistance may not necessarily change even as it loses filtration efficiency.

Changing filters more often than necessary results in excess expense to the user, particularly for expensive fine-particle IAQ filters commonly in use. Excessive filter changing also results in more landfill material and environmental impact. Some approaches have been proposed for equipping an HVAC filter with an indicator to alert the user that the filter needs changing. For example, U.S. Pat. No. 4,215,646 discloses a device that incorporates a whistle inserted through the filter media. When the filter clogs to a threshold extent, pressure differential across the filter causes airflow in the whistle passage, which eventually becomes large enough to cause the whistle to sound an audible tone and alert the user to change the filter. Other approaches have been described, for example in U.S. Pat. Nos. 3,635,001; 3,916,817; 4,747,364; 5,325,707; 6,110,260; 6,320,513; 6,412,435; 7,713,339; and 8,029,608 hereby incorporated by reference.

However, none of the previously described methods or devices have been deployed with significant commercial success, despite the fact that residential HVAC filter costs have escalated greatly in recent years.

The present invention provides an “indicator device” that is responsive to gaseous streams passing across, through, or near the device. As used herein, “responsive” refers to the indicator device reacting to passage of the gaseous stream. The components of the indicator device interact with the gaseous stream. In some embodiments, the indicator device indicates when an air filter should be changed. The indicator device alerts the user that the air filter has begun to lose efficiency and should be replaced. The indicator device of the present invention permits users to replace air filters based on need rather than simply a uniform, fixed time interval. The present invention provides an effective, low cost approach to air filter condition indication that can be easily deployed in settings such as a home or office, and provides robust and reliable indication of the air filter condition, allowing the user to decide to change air filters based on need, rather than on a uniform, fixed time interval. In some embodiments of the present invention, the indicator device utilizes color-change material that is responsive to air flow by changing color after interacting with passing air to provide an indication of the need to change the air filter.

As used herein, “color-change material” refers to a composition comprising color-change chemistry, which refers to the combination of an indicator dye and a reactive component. “Indicator dye” refers to a dye or combination of dyes that changes color with a change in pH. “Reactive component” refers to a compound that interacts with indicator gases or products formed from indicator gases coming into contact with the color-change material and thereby affects the color of the color-change material. “Indicator gases” refers to components in a gaseous stream that are absorbed by the indicator device, react with the color-change chemistry, and result in a change in pH. “Gaseous stream” refers to a composition in gaseous form that flows across, through, or near the indicator device. An example of a gaseous stream is an air stream. While many embodiments are disclosed herein in reference to an air stream, the embodiments also extend to gaseous streams in general.

As used herein, “indicator support media” refers to material or materials upon which color-change material can be applied and used in an indicator device. For instance, the indicator support media can be material which allows a gaseous stream to flow through the indicator device, such as porous paper, cloth, foam, synthetic fibrous material, or combinations thereof. The indicator support media can be any suitable thickness and width for the desired application.

As used herein, “indicator gas absorber material” refers to material applied to the indicator device to prolong the shelf life of the indicator device. The indicator gas absorber material enhances the absorption of the indicator gases by the indicator device.

As used herein, “occupied space” refers to an area of a building, such as a house, apartment, condominium, office, manufacturing facility, and the like, where humans or animals are present or may be present.

As used herein, “original state” refers to the initial condition of the indicator device and its components after manufacturing. “End-of-life” refers to the condition of an air filter when its service life is nearly over or is over. The indicator device of the present invention can be calibrated to indicate the end-of-life of the air filter or an intermediate stage in the service life of the air filter. The air filter includes “filter media” which is the material present in an air filter that traps or collects particles in a gaseous stream passing through the air filter.

As used herein, “integral color reference” refers to material that does not comprise the color-change chemistry and is used as a reference mark for the change in color exhibited in the indicator device over the use of the air filter to be monitored. The indicator device may be attached to the air filter by attachment elements or incorporated into the air filter prior to, during, or after manufacturing of the air filter. The attachment elements allow the indicator device to be connected to the air filter or any other suitable structure, such as a wall or door.

In some embodiments of the invention, color-change material is employed that may change color in response to the presence of an indicator gas within a gaseous stream. Examples of an indicator gas include carbon dioxide and/or oxygen and/or nitrogen and/or combinations thereof. Indicator gases may serve as a proxy for human and/or animal activity within an area, thereby providing an indication of the degree of filter loading that may occur as a result of occupant activity. The color-change material may change color after contacting a predetermined quantity of indicator gas, after being exposed to indicator gases for a predetermined time, after being exposed to a minimum flow velocity of air containing indicator gases, or a combination of time, quantity, and velocity. The color-change material and indicator device may be calibrated to change color after a desired period of time has passed, a desired amount of indicator gases have passed across, through, or near the indicator device, and/or a desired velocity of air has passed across, through, or near the indicator device.

Indicator devices according to the present disclosure may be configured to provide a visible color change in response to a predetermined total cumulative flow of air containing one or more indicator gases. Indicator devices may also be configured to provide a visible color change when a predetermined amount of filter clogging has occurred. Other indicator devices may change color in response to a combination of cumulative flow and filter clogging.

Some embodiments according to the present invention employ color-change material that may be responsive to a change in pH of an acid-base absorption pair. For instance, in some embodiments, an indicator gas such as carbon dioxide, which is typically present in the earth's air at about 400 parts per million, may interact with the color-change material to form carbonic acid, which may be sequestered as carbonate by a base and/or acid-base pair in the color-change material. Once the sequestration limits of the base and/or acid-base absorption pair are exceeded, further carbon dioxide absorption may reduce the pH of the base and/or acid-base absorption pair. These embodiments may further contain an indicator dye responsive to a change in pH, providing the basis for a visual color change.

In some embodiments, indicator device may be designed to have a specific capacity to absorb carbon dioxide. The specific absorption capacity may be selected to correspond to a predetermined amount of airflow. Once the predetermined amount of airflow has been exceeded, additional carbon dioxide absorption may result in lowering of the pH in the color-change material and may thereby change the color of the indicator device providing a visible color change.

In some embodiments, the color-change material may be impregnated within at least a portion of the filter media itself. Alternatively, it may be impregnated on indicator support media that may be affixed to, integrated within, or in proximity to, the filter media. Indicator support media may comprise, for example, a nonwoven sheet, paper, fabric, open cell foam, and the like in various combinations.

Embodiments that employ acid-base color change indication may be configured to change color after a specific amount of air has passed the indicator device which may be determined by the flow rate and amount of lapsed time. In these embodiments, the acid-base pair may be configured to change pH in proportion to the quantity of carbon dioxide absorbed, which may be related to the quantity of air flow across, through, or near the color-change material. After a specific total amount of air has passed across, through, or near the indicator device, the pH may have shifted sufficiently to cause a color change. Such action provides an indication of the need to change the filter. The indication is thereby related to the actual use of the filter. For instance, when higher flow rates of air pass across, through, or near the filter and indicator device, the pH of the color-change chemistry in the color-change material may shift to cause a color change after a smaller amount of time than in embodiments where lower flow rates of air pass across, through, or near the filter and indicator device. Such action provides earlier change indication for higher flow rates, and later change indication for lower flow rates, consistent with best practices for air filtration.

Some embodiments may include channels, which channel a portion of airflow impinging the surface of a filter to improve the rate of carbon dioxide absorption during airflow while inhibiting absorption when no airflow is present. Inhibition of carbon dioxide absorption during quiescent periods may be used to avoid false indication for filters that have very low duty cycle or long periods of inactivity. In some embodiments, the channels may include structures that mechanically deform in response to airflow and open or block passages channeling air to the color-change material, thereby closing the material from air contact during quiescent periods.

Some embodiments may include a method of preparing an indicator device. In some embodiments, a method of preparing an indicator device may comprise preparing a solution of a reactive component and an indicator dye. The method may also comprise adding optional additives such as acids, bases, surfactants, humectants, or combinations thereof. The method may comprise applying the solution of the reactive component, indicator dye, and optional additives to at least a portion of indicator support media and allowing the indicator support media to dry to prepare the indicator device.

Certain embodiments of the present invention comprise an air filtration system comprising an air filter and an indicator device. In some embodiments, the air filtration system may be connected to a heating system, ventilating system, air conditioning system, air filtration system, or combinations thereof. The air filtration system may be assembled by attaching an indicator device an air filter and covering at least a portion of the indicator device with a removable covering. The removable covering may substantially prevent air from contacting the color-change material of the indicator device during storage. As used herein “substantially prevent” refers to inhibiting most if not all air from entering the indicator device. In some embodiments, the indicator device is attached to a filter wherein at least a portion of a gaseous stream passing the filter impinges at least a portion of the indicator device once the indicator device is in use (and the removable cover, if used, has been removed).

Some embodiments of the indicator device may be prepared by impregnating indicator support media with a solution containing a reactive component and an indicator dye. The solution may be deposited on the indicator support media such that the solution impregnates the indicator support media.

Exemplary reactive components may include various combinations of acids and bases, including weak acids such as sodium bisulfate, acetic acid, sodium dihydrogen phosphate, citric acid, and the like. Weak bases may include tetramethylammonium carbonate, sodium bicarbonate, sodium carbonate, potassium carbonate, and sodium borate. Other bases may include tetramethylammonium hydroxide, sodium hydroxide, potassium hydroxide, and calcium hydroxide and combinations thereof. In some embodiments, the reactive component may react directly with the indicator gases while in other embodiments the reactive component may react with products formed from the indicator gases coming into contact with the color-change material. For instance, the reactive component may comprise a carbon dioxide absorber such as a carbamate-forming compound such as a tertiary amine.

Exemplary indicator dyes may include m-cresolsulfonephthalein, phenolphthalein, and sodium 5-(p-nitrophenylazo)benzenesulfonate. Other examples include conventional pH-sensitive indicator dyes such as metacresol purple, thymol blue, cresol red, xylenol blue, bromthymol neutral red, orange I and various combinations thereof.

In some embodiments, the color-change material may include water-attractive materials (humectants) to draw moisture into the medium from the atmosphere in order to facilitate the reaction between the reactive component and the indicator gases, for instance to facilitate the formation of carbonic acid from absorbed carbon dioxide. Such humectants may include glycerin, propylene glycol, dextrin, inorganic salts, and combinations thereof. Some embodiments may include additional dyes and or pigments to adjust the initial, intermediate, or final color of the color-change material. The color-change material may be designed to have a first and second color or a plurality of colors that correspond to various amounts of indicator gases. Other components such as polymers, salts, organic compounds, and dispersants may be added to obtain specific coating, drying, film, deposition, and/or gas diffusion properties. For instance, in one embodiment, the color-change material may comprise water, sodium bisulfate, sodium carbonate, ethanolamine, meta-cresol purple dye indicator, and glycerin.

The color-change material may be formed as a solution, which may be applied to indicator support media. In certain embodiments, the indicator support media is porous to allow a gaseous stream to pass through the support media. Suitable indicator support media include filter media, paper, cloth, foam, or the like, alone or in combinations thereof. After applying the color-change material to the indicator support media, the indicator support media may be dried at room temperature or at higher temperatures to remove most of the moisture. Residual moisture may remain in the color-change material.

In some embodiments of the invention, the color-change material may comprise one or more dyes and/or pigments in various combinations to impart a desired color to the indicator device in the indicator's original state or at other times during the use of the indicator device. Once the indicator support media comprising the color-change material is dried, the indicator device may be mounted on a filter, near a filter, or within a filter to serve as an indicator for the useful life of the filter. Multiple indicator devices may be applied to a single filter in various locations on, near, or within the filter. Without intending to be bound by theory, as a gaseous stream flows over the indicator device, a portion of one or more indicator gases within the gaseous stream is absorbed or “sampled” by the color-change material. The one or more indicator gases may react with the color-change chemistry in the color-change material. For instance, in one embodiment, absorbed carbon dioxide may be converted to carbonic acid by water contained within the color-change material in part due to the presence of a humectant such as glycerin. The carbonic acid may then be neutralized by sodium carbonate and thereby sequestered as bicarbonate. As more carbon dioxide is absorbed by the color-change material, the sodium carbonate may become depleted, and further carbonic acid formation may cause a drop in pH within the color-change material. Once the pH drops below a threshold value, the meta cresol purple indicator may change color from light blue-purple to white or yellow, thereby providing a visible color change.

In some embodiments, the indicator device may be prepared from a solution containing a solvent, reactive component, and indicator dye. For instance, the solution may comprise water, potassium hydroxide, and meta-cresol purple dye indicator. The solution may be applied to a porous support such as a portion of filter media, or paper, cloth, foam, or the like, and dried at an elevated temperature to remove most of the moisture. In some embodiments, residual water may be left in the color-change material. Once dried, the indicator device may then be mounted on, near, or within a filter to serve as an indicator device as disclosed above.

Exemplary solutions used to prepare color-change material for an indicator device according to the present disclosure may include water, a reactive component, an acid, an indicator dye, a humectant, and a surfactant.

In some embodiments, the color-change material may include a solvent at a concentration less than about 99% by weight of the solution, such as from about 10 to 99% by weight, or about 50 to 99% by weight. In one embodiment, the color-change material comprises about 80% to 98% by weight solvent. The solvent may be any suitable solvent, such as water.

In some embodiments, the color-change material may include a reactive component at a concentration less than about 90% by weight of the solution, such as less than about 80%, less than about 70%, or less than about 60% by weight of the solution. For instance, in some embodiments, the reactive component is present in the color-change material ranging from about 0.01% to 50% by weight of the solution, such as from 0.5% to 10% by weight of the solution.

In some embodiments, the color-change material may include an indicator dye at a concentration less than about 20% by weight of the solution, such as less than about 15% by weight, less than about 10%, or less than about 5% by weight of the solution. For instance, in some embodiments, the indicator dye is present in the color-change material ranging from about 0.001% to 2% by weight of the solution, such as about 0.1% to 1% by weight of the solution.

In some embodiments, the color-change material may include additional components such as acids, bases, humectants, surfactants, or combinations thereof. In certain embodiments, the color-change material may include one or more acid at a concentration ranging from about 0 to 70% by weight of the solution, such as about 0 to 50% by weight of the solution. In some embodiments, the color-change material may include one or more humectant in solution at a concentration ranging from about 0 to 50% by weight of the solution, such as about 0 to 20% by weight of the solution. In some embodiments, the color-change material may include one or more surfactant in solution at a concentration ranging from about 0 to 10% by weight, such as about 0.0001% to 0.2% by weight.

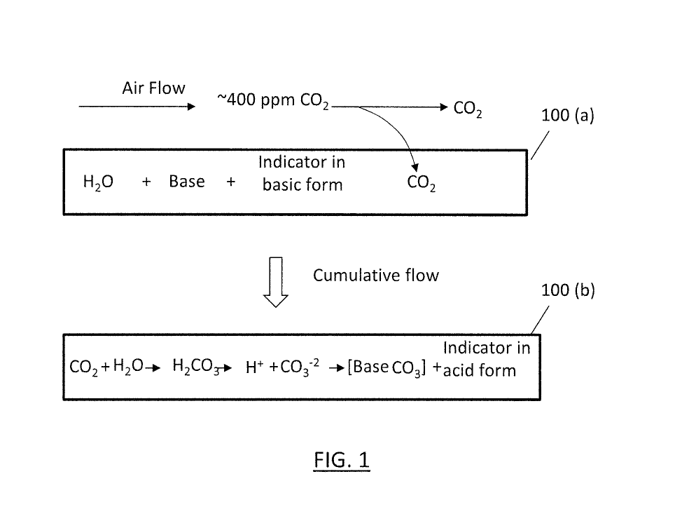

FIG. 1 is a schematic representation of an indicator device in accordance with some embodiments of the present invention. In FIG. 1, indicator devices 100(a) and 100(b) comprise indicator support media such as paper impregnated with color-change material comprising a reactive component and a residual amount of water as disclosed above. Indicator 100(a) illustrates the indicator in its original state, whereas indicator 100(b) illustrates the indicator after a specific cumulative amount of air has passed the indicator device. In indicator 100(a), the color-change material comprises an indicator dye in basic form having a first color. It will be understood that “basic form” refers to the state of the indicator in a basic or alkaline medium having a color that is distinct from the color of the indicator in an acidic medium. As illustrated in FIG. 1, air flowing over the surface of indicator 100(a) contains about 400 parts per million of carbon dioxide naturally present in terrestrial air. At least a portion of the carbon dioxide enters into indicator 100(a). At least a portion of the carbon dioxide entering indicator 100(a) reacts with residual water present in the indicator. At least a portion of the carbon dioxide is thereby converted to carbonic acid, as shown in indicator 100(b). At least a portion of carbonic acid thus formed reacts with the base, forming a base-carbonate salt, as shown in indicator 100(b). In the embodiment of FIG. 1, after a sufficient cumulative flow of air, absorption of carbon dioxide, conversion to carbonic acid, and formation of base-carbonate salt, further formation of carbonic acid causes an increase in acidity within the indicator, as shown in 100(b). An increase in acidity may cause conversion of the indicator dye from the basic form to the acid form, thereby converting the color of the color-change material from the first color to a second, visually distinct color.

In some embodiments, indicator devices may be fabricated as separate articles that may then be affixed to filters such as HVAC panel filters, with an adhesive backing or by other suitable mounting means. For instance, in some embodiments, the indicator devices are equipped with attachment elements such as magnets, tape, adhesives, brackets, hooks, hook and loop patches, or combinations thereof. The attachment elements may allow for permanent attachment or temporary attachment of the indicator devices to the filter. Such standalone indicators may be mounted to a filter installed in an HVAC system. In certain embodiments of the invention, the indicator device is positioned near the filter, and is not physically in contact with the filter. Standalone indicators may be supplied as stickers or decals that a user can easily apply to a filter. Portions of such indicators may be enclosed in a field-removable or peelable layer intended to prevent the indicator from absorbing indicator gas from the atmosphere during storage prior to deployment on a filter. The indicator device may be connected to the filter to be monitored by any suitable means. Attachment elements as described herein may be used in addition to other means for connecting the indicator device to the filter.

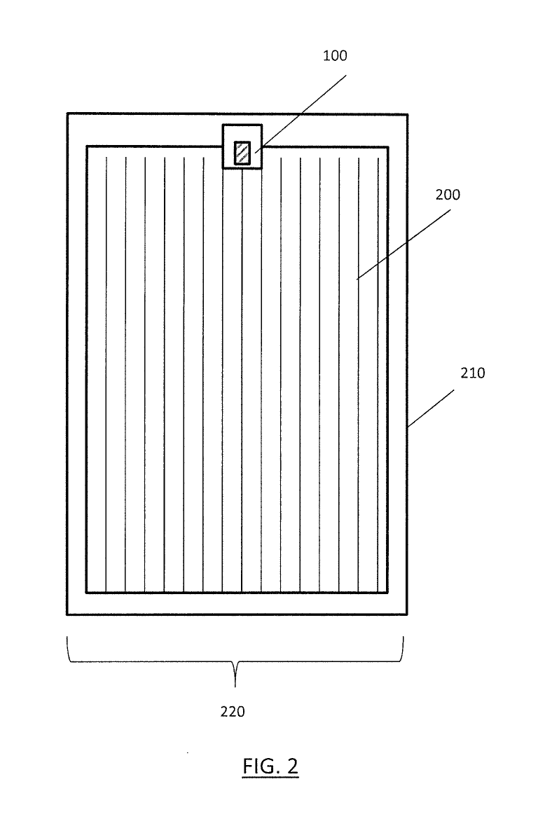

FIG. 2 is a schematic representation of a front (dwelling side) view of a filter with an indicator device mounted near the perimeter of the filter in accordance with some embodiments of the present invention. FIG. 2 illustrates a front view of a filter 220 with an indicator device mounted near the perimeter of the filter in some embodiments according to the present disclosure. In this embodiment, the front view of the filter is the side facing the dwelling. According to FIG. 2, indicator device 100 is configured to contact a portion of air entering or exiting filter media 200. Filter media 200 is secured within frame 210 and may be mounted in an air passage such that flow of air through filter media 200 is substantially perpendicular to the surface of filter media 200. Indicator device 100 may be mounted to filter 220 by various means including adhesives and tape. Indicator device 100 need not be aligned with airflow, and any convenient orientation may be used, for example in some embodiments, the indicator device may face outward to allow for visible inspection of the indicator device.

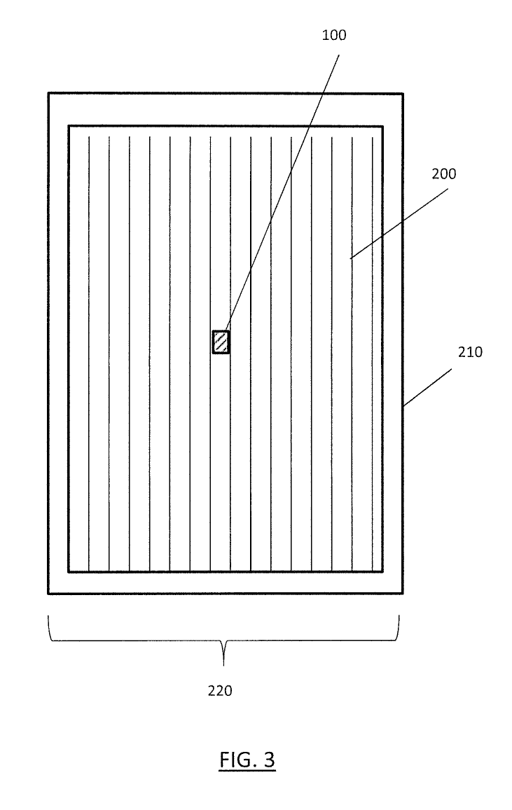

In other embodiments, indicator devices may be fabricated as an integral part of a filter, such as a panel filter for an HVAC system. In such embodiments, the indicator device may be easily visible on one side of the installed panel. FIG. 3 is a schematic representation of a front (dwelling side) view of a filter with a centrally mounted indicator device in accordance with some embodiments of the present invention. FIG. 3 illustrates a front (dwelling side) view of a filter 220 with a centrally mounted indicator device in some embodiments according to the present disclosure. According to FIG. 3, the indicator device 100 is configured as an integral part of filter media 200. The indicator device is further configured to contact a portion of air passing through the filter media 200. It will be understood that “integral part” refers to the indicator being manufactured as a component of filter 220 itself.

Filters manufactured with integral indicators may have a protective, field-removable layer to prevent the indicator from absorbing indicator gas from the atmosphere during storage prior to deployment on a filter. The field-removable layer may comprise indicator gas absorber material to prevent the indicator from absorbing indicator gas from the atmosphere during storage prior to deployment on a filter.

In some embodiments, an indicator gas absorber material may be included to prolong the shelf life of the indicator device and/or prolong the use of the indicator device. For instance, indicator gas absorber materials may include strong alkaline salts such as sodasorb, sodium or potassium hydroxide and the like, alone or in combination thereof. The indicator gas absorber material may be applied to the color-change material, incorporated in the color-change material, or applied elsewhere on the indicator device. For instance, the indicator gas absorber material may be incorporated elsewhere in the indicator device to selectively absorb ambient indicator gas during quiescent periods. Further, in some embodiments, the indicator gas absorber material may be separate from the indicator device or may be separable from the indicator device. In some embodiments, the indicator device may be designed to have a specific capacity to absorb carbon dioxide from a moving gaseous stream, while absorbing carbon dioxide to a lesser extent from a static atmosphere.

For example, in some instances it may be beneficial to have one or more indicator gas absorber materials located adjacent to or proximate to the indicator device, but as a separate component from the indicator device. In other embodiments, an indicator gas absorber material may be located as a component of the indicator device that can be removed when desired, such as with a label or backing material that can be peeled off when desired. The indicator gas absorber material may be more efficient at absorbing stagnant air than moving gaseous streams as compared to the color-change material, such that the use of indicator gas absorber material along with the indicator device is desired to prolong the use of the color-change material and allow the indicator device to more accurately monitor moving gaseous streams.

Some embodiments provide differential indicators whereby two or more indicators with differing capacities for indicator gas absorption are exposed to the same airflow. Such multi-segment indicators may be arrayed so that, as each indicator changes color after a predetermined flow, the array provides a visible delineation between a first color and final color that appears to proceed in a particular direction as more and more air passes the filter. Such an array may thereby provide “thermometer style” readout of filter use, with opposing endpoints indicating that the filter is new and that the filter needs changing with intermediate positions in between indicating intermediate filter life. The indicator device may comprise a first color-change material with a first color-change chemistry and a second color-change material with a second color-change chemistry. The color-change chemistry may vary with the amounts of reactive component and/or indicator dyes as well as other additives. A plurality of color-change materials may be used on the indicator device to prepare a multi-segment indicator device. For example, multiple segments of color-change material may be arrayed side by side, with each segment requiring greater exposure to indicator gas as one proceeds from left to right along the array. The far left segment may change color earliest in response to the indicator gas, followed by the second, the third, and so on along the array. Eventually all segments may change color, indicating that the filter should be changed. An indicator so configured provides a quasi-continuous readout, thereby providing an estimate of remaining filter life.

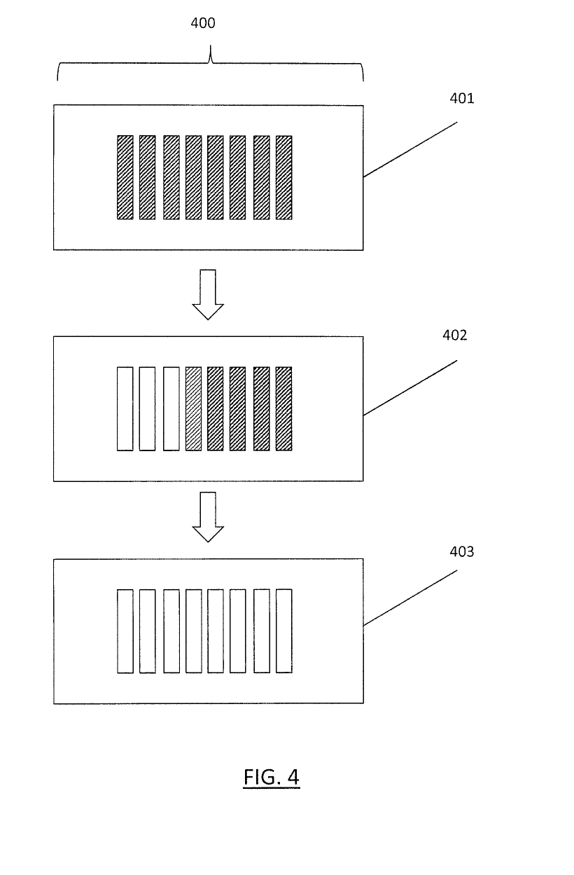

FIG. 4 is a schematic representation of a multi-segment indicator device at three stages of filter life in accordance with some embodiments of the present invention. As shown in FIG. 4, indicator 400 has eight separate segments. Each segment in this embodiment includes color-change material having a specific capacity for indicator gas so that each succeeding segment, moving from left to right in the figure, requires more airflow to change from a first color to a second color. As shown in FIG. 4, indicator 400 begins in its original state 401, with all segments exhibiting the same first color. After an intermediate amount of airflow has occurred, the indicator is in an intermediate state 402, in which the first three segments of indicator 400 have changed from a first color to a second color. After further airflow the indicator is now in an end-of-life state 403, with all segments having changed from a first color to a second color, signifying the need to change the filter. In some embodiments, the segments may have varying initial and final colors where the segments do not have the same initial color and/or do not have the same final color. Additional variations of this embodiment may be possible without deviating from the scope of the present disclosure.

Some embodiments provide a configuration wherein an indicator device is mounted on a filter panel, over a filter panel, within a filter panel, or combinations thereof. In some embodiments, more than one indicator may be mounted on a filter panel, over a filter panel, within a filter panel, or combinations thereof. For instance, in some embodiments, an indicator device may be located at a first position, a second position, or a plurality of positions. Airflow at one position may be lower than airflow at another position on the panel due to a radial air velocity gradient typical in panel filter installations, or due to intentional velocity gradients designed into the filter. When a radial gradient is present, for example, in installations where a panel filter is larger than the downstream duct carrying the airflow, and the panel is approximately centered over the duct, air velocity near the edge of the panel may only be a fraction of the air velocity at the center of the panel. Consequently, the filter may undergo flow velocity decay near the center of the filter at an earlier stage of filter clogging than near the edge of the filter, since material that clogs the filter may be initially deposited faster near the center. As the center of the filter begins to clog with particles, the flow rate at the edges of the filter may increase. In certain embodiments, a first position may be selected for placement of the indicator device near the edge of the panel whereby the indicator device may provide a more representative picture of filter clogging. For example, when placed near the lowest air velocity, an indicator device having a relatively fast rate of change in response to indicator gas may begin to change color only after significant clogging of the filter has occurred.

Some embodiments provide integral color reference material that enhances the visibility of the color change occurring during filter use. These assemblies may be configured to maximize the contrast of the color against a background to make it easier for an observer to see the color change and may be any appropriate word, symbol, image, and the like. For example a color-change material that is blue in its original state and turns white after a predetermined amount of filter use may be mounted as an island, or “dot” within a white background. Thus mounted, the blue dot may eventually disappear as the filter approaches end of life. Alternatively, a blue color-change material may be surrounded by a non-reactive material having an identical hue of blue. As the filter approaches end-of-life, a white dot may appear within the blue surrounding area. In other embodiments, a window in the surrounding material with identical hue may be cut stencil-wise in the form of the word “REPLACE”, or “CHANGE”, or similar words indicating that the filter needs to be changed. In such embodiments, the word(s) may not be visible as the first color, but may become visible only after the indicator has changed color. In other embodiments, one or more words, symbols, images, and the like may initially be visible and disappear after the indicator has changed color.

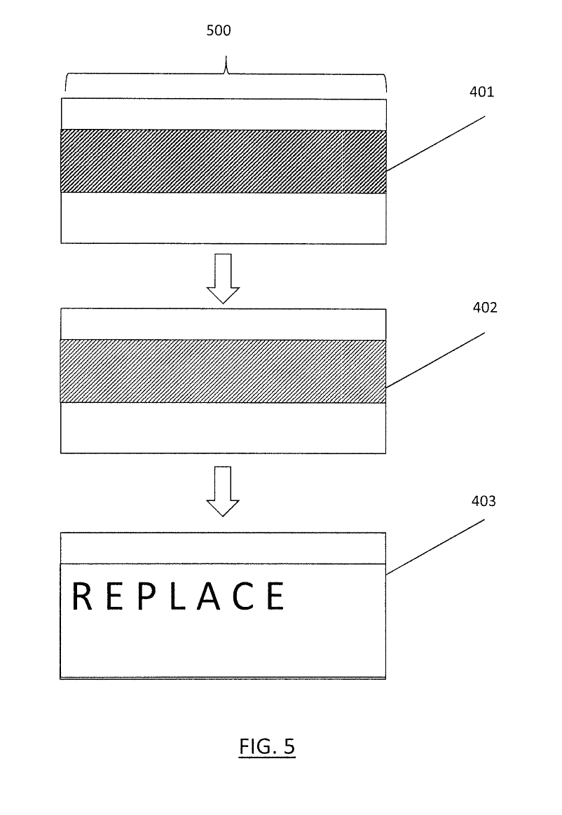

FIG. 5 is a schematic representation of an indicator device at three stages of filter life in accordance with some embodiments of the present invention. FIG. 5 illustrates an indicator device in some embodiments according to the present disclosure where the word “REPLACE” appears with use of the indicator device. According to FIG. 5, indicator device 500 is fabricated such that the word “REPLACE” is printed on the indicator device using an ink having a color similar to a first color corresponding to the original state 401 of indicator device 500. As air flows over indicator device 500, the color progressively changes from a first color to a second color and a third color, passing through an intermediate state 402 and reaching a final end-of-life state 403. In state 403, the indicator device reaches a third color, which contrasts to the original color of the word “REPLACE”, thereby making the word easily visible. Additional words, symbols, images, and the like may be used as desired.

Some embodiments may employ a filter bypass passage that permits air to flow past the filter without passing through the filter media. Bypass airflow may increase as the filter becomes clogged during use. The bypass passage may be equipped with a valve or other suitable device that allows the bypass passage to flow only when a specific pressure differential is exceeded across the filter. In these embodiments, an indicator device may be configured to contact a portion of bypass air, but is shielded from contact with non-bypass air. Bypass air may pass across, through, or near the indicator device or some combination thereof. After a certain amount of filter clogging has occurred, more air may be diverted to the bypass passage. The indicator device may thereby be exposed to greater flow of air, causing the color of the color-change material in the indicator device to change indicating that the filter should be changed. In related embodiments, an indicator device may be configured such that at least a portion of bypass air flows across, through, or near the indicator device itself.

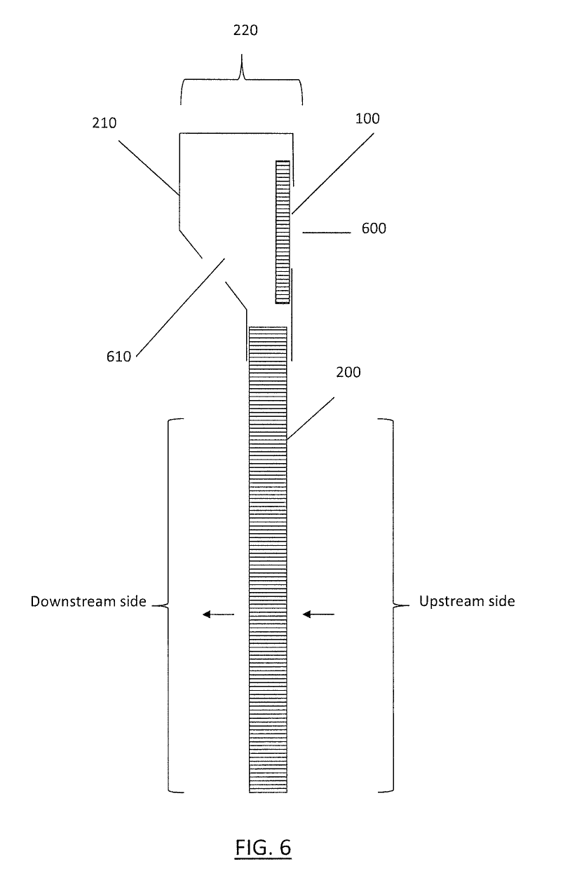

FIG. 6 is a schematic representation of an air filter with a bypass mode and an indicator device in accordance with some embodiments of the present invention. As shown in FIG. 6, indicator device 100 is configured to permit air to flow across, through, or near it, bypassing filter media 200. In this embodiment, indicator device 100 is positioned behind a first aperture 600 in filter frame 210. A second aperture 610 in frame 210 on the reverse side of filter 220 completes the bypass passage. During operation of the filter, the pressure difference between the front and back of filter 220 causes air to move through the bypass passage. The pressure differential increases during filter use as filter media 200 becomes clogged, thereby increasing flow through the bypass passage. Increased flow through the bypass passage causes the indicator device to change color, signifying the need to change the filter.

Some embodiments may employ an air filtration system that permits passage of air transversely through the indicator device only after exceeding a prescribed pressure differential across the filter. For example, an indicator device fabricated using indicator support media such as porous paper and configured in a filter bypass arrangement described above may be designed in the air filtration system such that little or no air flow occurs through the indicator device below a threshold pressure differential. Above the threshold pressure differential, some flow may occur through the indicator device, causing a color change after a prescribe amount of air flow. In some embodiments, the pressure differential may be between 0.01″ and 2″ of water column, as measured by a water gauge. In other embodiments, the pressure differential may be between 0.05″ and 0.25″ water column.

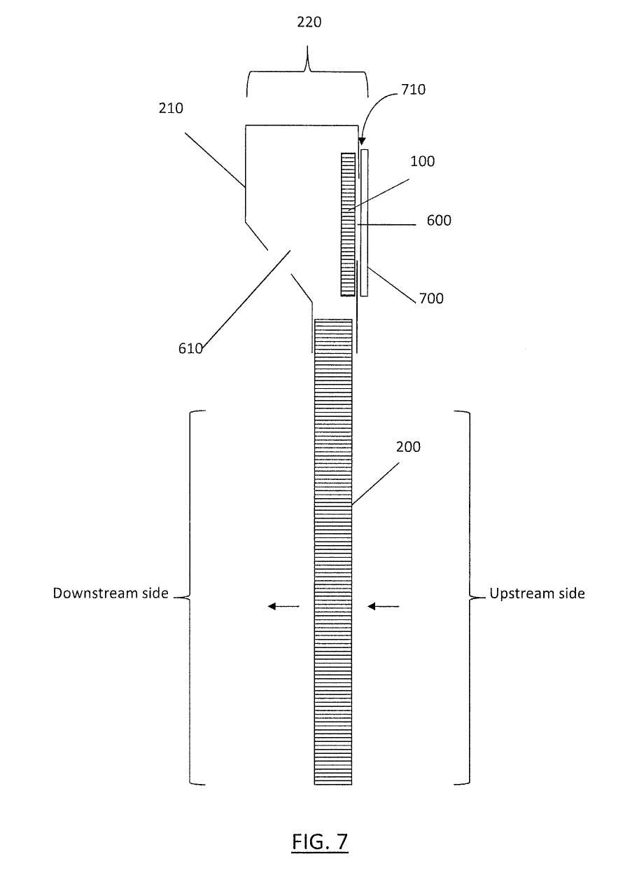

FIG. 7 is a schematic representation of an air filter with a bypass mode and an indicator device with a protective transparent cover in accordance with some embodiments of the present invention. As shown in FIG. 7, indicator device 100 is configured to permit air to flow across, through, or near it, bypassing filter media 200. Indicator device 100 is positioned behind a first aperture 600 in filter frame 210. First aperture 600 is positioned behind transparent cover 700. The edge of transparent cover 700 forms bypass channel 710 where it meets filter frame 210. Bypass channel 710 is configured to regulate the amount of air allowed to enter aperture 600. A second aperture 610 in frame 210 on the reverse side of filter 220 completes the bypass passage. In the embodiment of FIG. 7, when the pressure differential between the front and back of filter 220 exceeds the pressure necessary to cause air to flow through the bypass channel, air flows through the bypass channel 710 and indicator device 100. The pressure differential increases during filter use as filter media 200 becomes clogged, causing an increase in air flowing through the bypass channel 710 and indicator device 100.

Embodiments that include an electrostatic filter media, or so-called “electret” type media may benefit from filter change-out schedules that are determined by time and/or air flow, or a product of time and air flow (integrated time-flow or cumulative flow), rather than by a specific amount of clogging or pressure drop. This may be due to the time and flow dependence of electrostatic charge decay in such filters. The electrostatic filter media may not necessarily clog as it traps particles, but may become ineffective nevertheless. In these embodiments, an indicator device may be positioned on the main body of air flow, in the main body of air flow, and/or near the main body of air flow and thereby provide accurate indication of cumulative flow through the filter. For example, an indicator device may be positioned near the center of an electret filter panel to intercept the highest rate of airflow. In this position, the indicator device may change color after a predetermined cumulative airflow, rather than after a specific amount of clogging or pressure drop, thereby indicating that the electret material has decayed to a point where the filter should be changed.

Some embodiments may use an indicator device with split color-change material. In some embodiments, split color-change material may have a portion of a color-change material exposed to air flow with another portion of the same color-change material sealed from contact with air. A border between the exposed and unexposed areas may be defined as the boundary between the two areas. The color-change material may be configured to permit components impregnated on the material to migrate across the boundary between exposed and unexposed portions. For example, a color-change material may be made by impregnating indicator support media. The indicator support media may then be configured on an air filter, in an air filter, near an air filter, or combinations thereof such that a portion of the color-change material is in contact with air moving through the filter while a different portion is sealed against contact with air, for example, with tape. As air flow on the exposed portion of the color-change material begins to shift the color of that portion, materials from the unexposed portion may migrate through the body of the indicator device toward the exposed portion to re-establish a more consistent concentration of components in both portions. After sufficient migration has occurred, the unexposed portion may begin to change color as well. Migration of material from unexposed portion to exposed portion may thereby permit the paper to contact a larger cumulative air flow before changing color. Without intending to be bound by theory, the unexposed portion thereby acts as a reservoir of material to replenish the exposed portion and thereby increase its capacity for cumulative exposure to air flow. This may permit greater design flexibility in establishing a predetermined cumulative air flow corresponding to a desired color change.

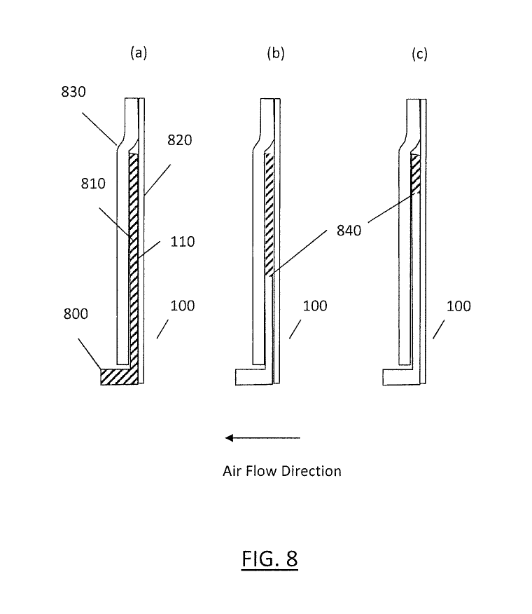

FIG. 8 is a schematic representation of an indicator device in a linear split configuration at three stages of filter life in accordance with some embodiments of the present invention. In the embodiment illustrated in FIG. 8, color-change material 110 is sandwiched between a transparent window 820 and a backing 830. A portion of color-change material 110 is not enclosed and comprises exposed area 800. Exposed area 800 is configured to contact a portion of air flowing through a filter. The portion of color-change material 110 that is enclosed comprises unexposed area 810. The original state is illustrated in FIG. 8(a). In FIG. 8(a), color-change material 110 is a uniform first color throughout its area. Air flowing past the indicator device causes the color to change from a first color to a second color in exposed area 800. As more airflow passes the indicator device, color change begins to occur within the unexposed area 810. Color change within area 810 creates a border 840 between the original first color and the new second color. Border 840 appears through window 820 to migrate upward in the window as more air flows. After an intermediate amount of airflow, as shown in FIG. 8(b), border 840 appears about midway in transparent window 820. After sufficient airflow the filter reaches an end-of-life state, where border 840 appears near the top of transparent window 820 as in FIG. 8(c), signifying that the filter is at its end-of-life.

In some embodiments, the indicator device has a split color-change material with a border between a first area on the exposed portion that has a first color, and a second area on the exposed portion that has a second color. The first color may be the color the indicator changes to after exposure to a predetermined cumulative air flow, as disclosed above, while the second color may be the same as the original color of the unexposed portion. The first area may be more distant from the unexposed portion, while the second area may be adjacent to the unexposed portion. As material is depleted from the unexposed portion, the border between the first color and the second color may migrate toward the boundary between the exposed and unexposed portions, thereby providing continuous indication of the cumulative air flow through the filter. Migration of the boundary may be visible for inspection and provide an indication of filter usage and estimate of remaining life.

In some embodiments, the indicator device may have split color-change material so that any unexposed portion is visible for inspection. The unexposed portion may be sealed, for example, with transparent tape. For inspection purposes, the indicator device may be visible behind the transparent tape, whereas the exposed portion may not be visible. As explained above, as the unexposed portion is depleted by migration of components to the exposed portion, its color may change. In other embodiments, the configuration may be reversed so that the exposed portion is visible and the unexposed portion is not visible. In yet other embodiments, both the exposed and unexposed portions may be visible for inspection.

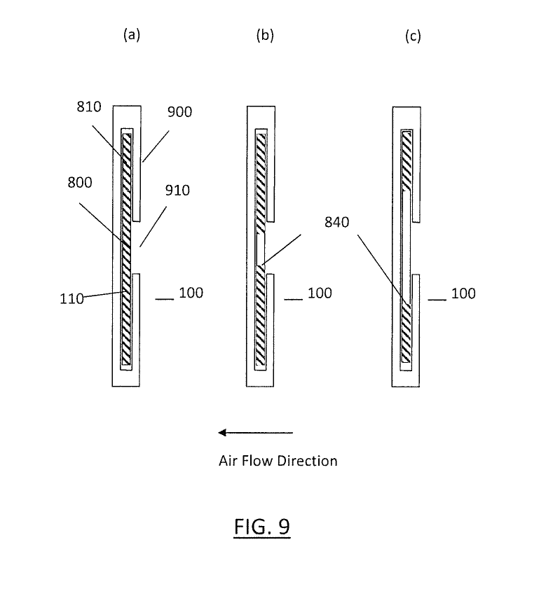

FIG. 9 is a schematic representation of an indicator device in a radial split configuration at three stages of filter life in accordance with some embodiments of the present invention. In the embodiment of FIG. 9(a), color-change material 110 is enclosed in an opaque cover 900 leaving a small portion of color-change material 110 exposed to the air through aperture 910. Exposed area 800 is configured to contact a portion of air flowing through a filter. In its original state, color-change material 110 has a uniform first color throughout its entire area as illustrated in FIG. 9(a). As air flows over the exposed area 800, its color begins to change from a first color to a second color, forming a circular area within the exposed area that expands as more air flows. Color change within area 800 creates a border 840 between the original first color and the new second color. During intermediate state, border 840 is visible through aperture 910, as in FIG. 9(b). The border eventually migrates into unexposed area 810, leaving the entire exposed area a uniform second color, signifying filter has reached the end-of-life state, as in FIG. 9(c).

Some embodiments that employ migration of materials through an indicator device medium may be configured such that only the edges of the medium are exposed to an air flow, while the remainder of the medium is sealed against contact from the air. For example, an indicator device made as disclosed above utilizing filter paper with front and rear surfaces may be sandwiched between two other layers where at least one of these layers may be transparent and may further contain a window for viewing some or all of the color-change material. The sandwiched indicator may then be mounted such that at least a portion of the edges of the indicator device come into contact with a moving stream of air, while the front and rear surfaces are substantially sealed against contact from air. As indicator gas is absorbed at the edges of the indicator device, rebalancing of components within the indicator device proceeds as disclosed above. Eventually, after sufficient indicator gas has been absorbed, the color change boundary proceeds sufficiently to become visible through the transparent layer.

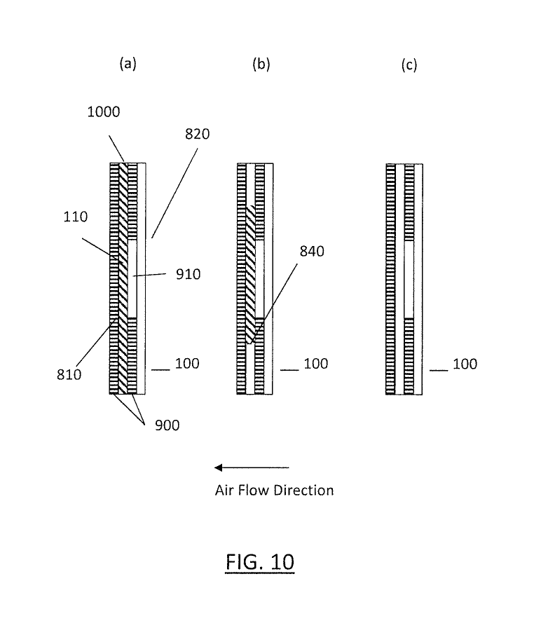

FIG. 10 is a schematic representation of an indicator device in a radial split configuration with exposed edges at three stages of filter life in accordance with some embodiments of the present invention. As shown in FIG. 10(a), color-change material 110 is enclosed in an opaque cover 900 leaving only edges 1000 of the indicator device 100 exposed to the air. Exposed edge 1000 is configured to contact a portion of air flowing through a filter. In its original state, color-change material 110 has a uniform first color throughout its entire area, as illustrated in FIG. 10(a). As air flows over the exposed edge 1000, the color of exposed edge 1000 begins to change from a first color to a second color, forming an annular area within the enclosed portion that expands inwardly as more air flows. Color change within color-change material 110 creates a border 840 between the original first color and the new second color. During an intermediate state as shown in FIG. 10(b), border 840 is not visible through aperture 910. After sufficient airflow exposure at edges 1000, the border migrates into the unexposed area enclosed by aperture 910, leaving the entire exposed area a uniform second color, signifying filter has reached the end-of-life state shown in FIG. 10(c).

In some embodiments, the color change of the indicator devices disclosed herein may be read electronically instead of, or in addition to visual means. Electronic readout may provide greater accuracy in color readings, and may provide finer resolution of the precise color of the indicator device, thereby providing more precise indication of filter use and/or remaining life. Electronic color readout may be accomplished, for example, by using a digital color camera or other suitable sensor capable of resolving an image into component colors, such as red, blue, and green. Devices containing digital cameras, such as cell phones, smart phones, and tablets may be suitable for reading the color of the indicator device.

Some embodiments may make use of smart phone or tablet software applications, or “apps” that include color reading, analysis, and a user interface. An app may be configured to employ a device's onboard camera to capture an image of the indicator device; analyze the color by separating the image into its component colors such as red, blue, and green; and calculating the filter status corresponding to the precise color state of the indicator device and combinations thereof. Finally, the app may provide a result of the analysis to the user in the form of a graphic or text based display on the device. Apps may also provide estimates of remaining filter life, and may further provide filter check and/or change reminders to the user in the form of calendar entries, emails, text messages, and the like.

In embodiments employing electronic color reading, color analysis may consist of the steps of separating the color into its primary components such as red, green and blue; calculating the color state of the indicator device by differentially comparing the component colors, for example the ratio of the magnitude of the green component to the magnitude of the blue component; converting the differential color reading to a “filter use metric”, a value representing the amount of cumulative use the filter has seen; presenting the filter use metric to a user for indicating remaining filter life or indicating that the filter should be changed; and combinations thereof. The ratio of green to blue may be compared with the color of a separate area, for example a white border around the indicator device, in order to correct for variation in exposure conditions.

Some embodiments may employ an indicator device that is mounted in a location that is generally visible to an occupant and/or inspector on the outside of the filter fixture. The indicator device may be mounted, for example, on the occupied space side of the filter fixture door. Such mounting may permit the indicator device to contact air moving through louvers or passages in the fixture door. Mounting may be accomplished, for example, with magnets, clips, hooks, tape, or the like. In these embodiments, the term “generally visible” means that the indicator device may be seen by an observer without having to open or disassemble the filter housing. Such visibility may be desired where filter fixtures are inconveniently located, for example, in a ceiling, or where fixtures require tools for disassembly to access the filter therein. Some embodiments include an indicator device that is integrated with, or built into the filter housing door itself.

### EXAMPLES

### Example 1

A solution was prepared by combining 0.6 grams sodium carbonate (anhydrous), 5.0 grams glycerin, 0.1 gram meta cresol purple indicator (sodium salt), and 94 grams of distilled water, and stirring to dissolve all components. A deeply colored blue solution was obtained. Aliquots of 10 microliters of the solution were separately applied to portions of Whatman number 1 filter paper. The paper was dried at room temperature for 1 hour, resulting in a disk of blue-violet color in the dried paper. A portion of this paper having a consistent continuous color was cut into a square of about ¼ inch by ¼ inch and affixed to the frame of a pleated HVAC filter such that one surface was expose to air. The filter was placed in an HVAC return air receptacle and used to filter air for a period of three months. The color of the indicator was blue-violet at the beginning of the filtration period, and gradually changed to pale yellow through the test period. After the third month, the color of the indicator was stable and remained pale yellow.

### Example 2

A solution was prepared by combining 3.0 grams of solid potassium hydroxide (anhydrous), 0.25 grams of metacresol purple indicator (sodium salt), and 97.0 grams of water, and stirring to obtain a clear solution having a deep blue color. Portions of this solution were distributed on Whatman Number 1 filter paper at a rate of 0.024 milliliters per square centimeter of paper and allowed to soak the paper thoroughly. The paper was allowed to dry for 5 minutes at room temperature, and then baked at 200 degrees F. in an oven for 10 minutes. The baked paper was uniform blue-violet in color and dry to the touch. The paper was cut into 1 cm squares and affixed to the grille of an HVAC filter receptacle such that the portion facing the room was exposed to air entering the face of the grille. Air flowed through the filter receptacle continuously at a face velocity of about 400 feet per minute. The color of the indicator was blue-violet at the beginning of the filtration period, and gradually changed to yellow-orange through the test period. After 360 hours of continuous airflow, the indicator was completely yellow-orange in color, and remained so even after removal from the filter receptacle.

The concepts discussed herein may be extended to additional embodiments not necessarily using a filter or more specifically an air filter. For instance the indicator device could be used in other applications where carbon dioxide or other indicator gases may be present and where it is desired to monitor the presence of such gases. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An indicator device responsive to gas flow comprising:
indicator support media and
a first color-change material deposited on at least a portion of the indicator support media, wherein the first color-change material comprises a reactive component that reacts with one or more indicator gases in the gas flow and causes the first color-change material to change color, wherein the indicator gases are at least one of carbon dioxide or nitrogen; and
an indicator dye.

2. The indicator device according to claim 1, wherein the indicator support media comprises paper, cloth, foam, synthetic fibrous material, or a combination thereof.

3. The indicator device according to claim 1, wherein the indicator support media comprises filter paper.

4. The indicator device according to claim 1, wherein the reactive component comprises a solid material that is impregnated in the indicator support media.

5. The indicator device according to claim 1, wherein the reactive component comprises one or more alkaline materials.

6. The device according to claim 1, wherein the reactive component reacts with the one or more indicator gases when the gas flow passes across, through, or near the indicator device.

7. The indicator device according to claim 1, wherein the gas flow comprises an air stream entering an air filter or an air stream exiting an air filter.

8. (canceled)

9. (canceled)

10. The indicator device according to claim 1, wherein the reactive component is selected from one or more of quaternary ammonium hydroxides, alkali hydroxides, alkaline earth hydroxides, and combinations thereof.

11. The indicator device according to claim 1, wherein the reactive component comprises tetramethylammonium hydroxide, potassium hydroxide, sodium hydroxide, calcium hydroxide, or combinations thereof.

12. The indicator device according to claim 1, wherein the reactive component is selected from one or more quaternary ammonium carbonates, alkali carbonates, alkaline carbonates, and combinations thereof.

13. The indicator device according to claim 1, wherein the reactive component comprises tetramethylammonium carbonate, sodium carbonate, potassium carbonate, or combinations thereof.

14. The indicator device according to claim 1, wherein the indicator dye comprises a compound that changes from a first color to a second color with a change in pH.

15. The indicator device according to claim 1, wherein the indicator dye comprises one or more pH indicators selected from the group consisting of phenol red, thymol blue, metacresol purple, bromthymol blue, bromcresol green, methyl red, phenolphthalein, thymophthalein, cresol red, and alizarin yellow R.

16. The indicator device according to claim 1, further comprising one or more integral color references within or adjacent to the first color-change material.

17. The indicator device according to claim 1, further comprising one or more attachment elements.

18. The indicator device according to claim 17, where the attachment elements comprises magnets tape, adhesives, brackets, hooks, hook and loop patches, or combinations thereof.

19. The indicator device according to claim 1, further comprising a second color-change material comprising a reactive component and an indicator dye wherein the second color-change material changes color when activated by a gaseous stream passing across, through, or near the indicator device.

20. The indicator device according to claim 1, wherein the first color-change material forms a word, symbol, image, or combinations thereof on the indicator support media.

21. A method of preparing an indicator device comprising:
a. preparing a first color-change material comprising an indicator dye and a reactive component that reacts with one or more indicator gases in the gas flow and causes the first color-change material to change color; wherein the indicator gases are at least one of carbon dioxide or nitrogen;
b. applying the first color-change material to at least a portion of an indicator support media; and
c. drying the indicator support media to obtain the indicator device.

22. The method of claim 21, further comprising adding one or more acids, surfctants, humectants, or combinations thereof to the first color-change material.

23. The method of claim 21, further comprising preparing a second color-change material, applying the second color-change material to the indicator support media, and drying the second color-change material, wherein the second color-change material changes color when activated by a gaseous stream passing across, through, or near the indicator device.

24. An air filtration system comprising:
an air filter and
the indicator device according to claim 1.

25. The air filtration system according to claim 24 connected to a heating system, ventilating system, air conditioning system, air filtration system, or combinations thereof.

26. A method of assembling an air filtration system comprising the steps of:
attaching the indicator device according to claim 1 to an air filter; and
covering at least a portion of the indicator device with a removable covering, wherein the removable covering substantially prevents air from contacting the first color-change material during storage.

27. The indicator device according to claim 19, wherein the reactive component in the second color-change material reacts with one or more indicator gases in the gas flow and causes the second color-change material to change color, wherein the indicator gases are at least one of carbon dioxide or nitrogen.
